(19) United States
(12) Patent Application Publication
(10) Pub. No.: US 2026/0320757 A1
(43) Pub. Date: Oct. 15, 2026

(54) METHOD FOR PROCESSING MEDICAL IMAGES, MEDICAL DEVICE, AND NON-TRANSITORY COMPUTER-READABLE MEDIUM

(71) Applicant: GE Precision Healthcare LLC, Waukesha, WI (US)

(72) Inventors: Gang Liu, Wuxi (CN); Yuanlong Meng, Wuxi (CN); Zhiwen Wang, Wuxi (CN); Longfei Wu, Wuxi (CN)

(21) Appl. No.: 19/643,312

(22) Filed: Apr. 9, 2026

(30) Foreign Application Priority Data
Apr. 9, 2025 (CN) 202510442525.9

(51) Int. Cl. G06T 5/70

(52) U.S. Cl. CPC G06T 5/70; G06T 2207/10132; G06T 2207/30004

(57) ABSTRACT

A method for processing medical images includes: processing data of a raw three-dimensional medical image to obtain mask data of a noise-free region; processing the data of the raw three-dimensional medical image according to the mask data of the noise-free region to generate data of a denoised three-dimensional medical image; and adding, in response to a first operation, at least a portion of the data of the raw three-dimensional medical image to the data of the denoised three-dimensional medical image. Using this method noise can be efficiently removed from the raw three-dimensional medical image; furthermore, at least a portion of the data of the raw three-dimensional medical image can be added to the denoised three-dimensional medical image according to an operation by a physician, thereby enabling restoration of the three-dimensional medical image and thus preserving effective information in the image.

### CROSS-REFERENCE TO RELATED APPLICATION

This application claims priority to Chinese Patent Application No. 202510442525.9, which was file on Apr. 9, 2025 at the Chinese Patent Office. The entire contents of the above-listed application are incorporated by reference herein in their entirety.

### TECHNICAL FIELD

Embodiments of the present application relate to the technical field of medical imaging, and in particular, to a method for processing medical images, a medical apparatus, and a non-transitory computer-readable medium.

### BACKGROUND

Medical imaging devices can non-invasively obtain internal tissue images of a subject to be imaged. For example, a scanning device of the medical imaging device may scan a predetermined site of the subject to be imaged to obtain imaging data containing information about the predetermined site.

Common medical imaging devices are, for example, ultrasound imaging systems, magnetic resonance imaging (MRI) systems, computed tomography (CT) scanning systems, etc.

After a medical imaging device scans a subject to be imaged, a two-dimensional (2D) medical image or a three-dimensional (3D) medical image is generated. A physician may make a diagnosis based on the 2D medical image or the 3D medical image.

In some medical imaging scenarios, a three-dimensional medical image corresponding to each moment can be generated, thereby forming a plurality of frames of three-dimensional medical images in a time sequence. These three-dimensional medical images are tagged with time information. When the three-dimensional medical images are viewed in the time sequence, a four-dimensional imaging result for the subject to be imaged can be displayed.

It should be noted that the above introduction of the background is only for the convenience of clearly and completely describing the technical solutions of the present application, and for the convenience of understanding for those skilled in the art.

### SUMMARY OF THE INVENTION

According to an aspect of the embodiments of the present application, a method for processing medical images is provided. The method comprises:
processing data of a raw three-dimensional medical image to obtain mask data of a noise-free region;
processing the data of the raw three-dimensional medical image according to the mask data of the noise-free region to generate data of a denoised three-dimensional medical image; and
adding, in response to a first operation, at least a portion of the data of the raw three-dimensional medical image to the data of the denoised three-dimensional medical image.

According to another aspect of the embodiments of the present application, a medical apparatus is provided. The medical apparatus comprises:
a data collection unit that collects data of a raw three-dimensional medical image; and
a processing unit that executes the method for processing medical images as described in the foregoing embodiments.

According to still another aspect of the embodiments of the present application, a non-transitory computer-readable medium is provided. The non-transitory computer-readable medium stores a computer program, and when executed by a computer, the computer program causes the computer to execute the steps of the method as described in the above embodiments.

One of the beneficial effects of the embodiments of the present application is that: In the method for processing medical images, mask data of a noise-free region is generated according to data of a raw three-dimensional medical image, and the mask data and the data of the raw three-dimensional medical image are processed to generate a denoised three-dimensional medical image, thereby enabling efficient removal of noise from the raw three-dimensional medical image; furthermore, at least a portion of the data of the raw three-dimensional medical image can be added to the denoised three-dimensional medical image according to an operation by a physician, thereby enabling restoration of the three-dimensional medical image and thus preserving effective information in the image.

With reference to the following description and drawings, specific implementations of the embodiments of the present application are disclosed in detail, and the way in which the principles of the embodiments of the present application can be employed are illustrated. It should be understood that the implementations of the present application are not limited in scope thereby. Within the scope of the spirit and clauses of the appended claims, the implementations of the present application comprise many changes, modifications, and equivalents.

### BRIEF DESCRIPTION OF THE DRAWINGS

The included drawings are used to provide further understanding of the embodiments of the present application, which constitute a part of the description and are used to illustrate the implementations of the present application and explain the principles of the present application together with textual description. Evidently, the drawings in the following description are merely some embodiments of the present application, and those of ordinary skill in the art may obtain other implementations according to the drawings without involving inventive effort. In the drawings:

FIG. 1 is a schematic diagram of a method for processing medical images according to some embodiments of the present application;

FIG. 2 is a schematic diagram of a raw three-dimensional medical image according to some embodiments of the present application;

FIG. 3 is a schematic diagram of an image corresponding to mask data of a noise-free region according to some embodiments of the present application;

FIG. 4 is a schematic diagram illustrating generation of a denoised three-dimensional medical image and a three-dimensional medical image reflecting noise according to some embodiments of the present application;

FIG. 5 is a schematic diagram of processing in response to a first operation according to some embodiments of the present application;

FIG. 6 is a schematic diagram of the processing in response to the first operation in a case where three-dimensional medical images are displayed in a linked manner in a first display region and a second display region according to some embodiments of the present application;

FIG. 7 is a schematic diagram of a display screen when the three-dimensional medical images are displayed in a linked manner in the first display region and the second display region according to some embodiments of the present application;

FIG. 8 is another schematic diagram of the display screen when the three-dimensional medical images are displayed in a linked manner in the first display region and the second display region according to some embodiments of the present application;

FIG. 9 is a schematic diagram of a medical apparatus according to an embodiment of the present application; and

FIG. 10 is a schematic diagram of an ultrasound imaging system according to an embodiment of the present application.

### DETAILED DESCRIPTION

In some cases, three-dimensional medical images contain background noise, which may affect the imaging effect and consequently may influence the physician's diagnosis results. For example, when four-dimensional hysterosalpingo-contrast sonography (HyCoSy) is performed using an ultrasound imaging system, a contrast agent is injected into the vaginal cavity of a subject to be imaged to improve the imaging quality. However, the contrast agent will introduce background noise into the three-dimensional medical images, thereby affecting the observation of the three-dimensional medical images by the physician.

To reduce the background noise in the three-dimensional medical images, the physician typically needs to manually remove portions of the background noise using an image processing tool. For example, the physician performs operations such as rotating, moving, or scaling a three-dimensional medical image on a display interface for the three-dimensional medical image, and selects a noise region in the three-dimensional medical image using the image processing tool to perform a deletion operation, etc.

Manual removal of background noise is time-consuming and labor-intensive. For example, the physician sometimes needs to spend tens of minutes performing the background noise removal work, which affects the physician's work efficiency and increases the workload. Therefore, how to remove background noise from three-dimensional medical images using an efficient method is a problem that needs to be solved.

To solve at least one of the aforementioned technical problems or similar technical problems, embodiments of the present application provide a method for processing medical images, a medical apparatus, and a non-transitory computer-readable medium. According to an embodiment of a method of processing medical images, mask data of a noise-free region is generated according to data of a raw three-dimensional medical image, and the mask data and the data of the raw three-dimensional medical image are processed to generate a denoised three-dimensional medical image, thereby enabling efficient removal of noise from the raw three-dimensional medical image; furthermore, at least a portion of the data of the raw three-dimensional medical image can be added to the denoised three-dimensional medical image according to an operation by a physician, thereby enabling restoration of the three-dimensional medical image and thus preserving effective information in the image.

The aforementioned and other features of the embodiments of the present application will become apparent from the following description with reference to the drawings. In the description and drawings, specific implementations of the present application are disclosed in detail, and part of the implementations in which the principles of the embodiments of the present application may be employed are indicated. It should be understood that the present application is not limited to the described implementations. On the contrary, the embodiments of the present application include all modifications, variations, and equivalents which fall within the scope of the appended claims.

In the embodiments of the present application, the terms “first”, “second”, etc., are used to distinguish different elements from one another by title, but do not represent the spatial arrangement, temporal order, etc., of the elements, and the elements should not be limited by said terms. The term “and/or” includes any one of and all combinations of one or more associated listed terms. The terms “comprise”, “include”, “have”, etc., refer to the presence of stated features, elements, components, or assemblies, but do not exclude the presence or addition of one or more other features, elements, components, or assemblies. The terms “pixel” and “voxel” may be used interchangeably.

In the embodiments of the present application, the singular forms “a”, “the”, etc., include plural forms, and should be broadly construed as “a type of” or “a class of” rather than being limited to the meaning of “one”. Furthermore, the term “the” should be construed as including both the singular and plural forms, unless otherwise explicitly specified in the context. In addition, the term “according to” should be construed as “at least in part according to . . . ”, and the term “based on” should be construed as “at least in part based on . . . ”, unless otherwise explicitly specified in the context.

The features described and/or illustrated for one embodiment may be used in one or more other embodiments in an identical or similar manner, combined with features in other embodiments, or replace features in other embodiments. The term “include/comprise” when used herein refers to the presence of features, integrated components, steps, or assemblies, but does not exclude the presence or addition of one or more other features, integrated components, steps, or assemblies.

Some embodiments of the present application provide a method for processing medical images.

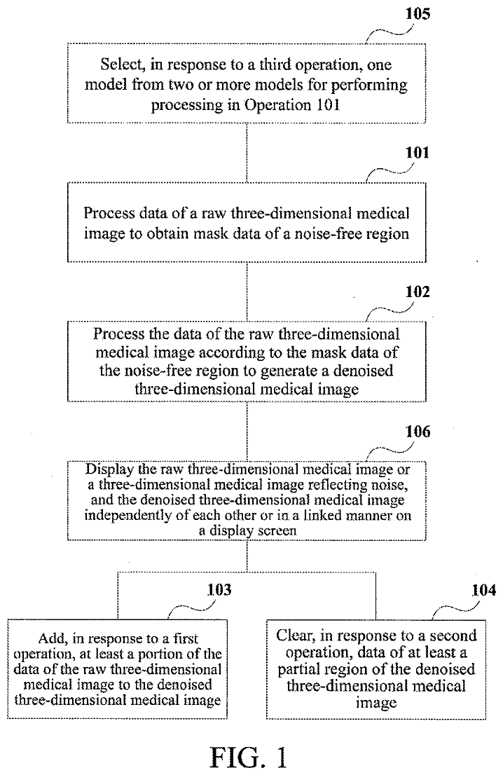

FIG. 1 is a schematic diagram of a method for processing medical images according to some embodiments of the present application. As shown in FIG. 1, the method for processing medical images includes:

Operation 101: processing data of a raw three-dimensional medical image to obtain mask data of a noise-free region;

Operation 102: processing the data of the raw three-dimensional medical image according to the mask data of the noise-free region to generate data of a denoised three-dimensional medical image; and

Operation 103: adding, in response to a first operation, at least a portion of the data of the raw three-dimensional medical image to the denoised three-dimensional medical image.

According to the embodiments of the present application, in the method for processing medical images, the mask data of the noise-free region is generated according to the data of the raw three-dimensional medical image, and the mask data and the data of the raw three-dimensional medical image are processed to generate the denoised three-dimensional medical image, thereby enabling efficient removal of the noise from the raw three-dimensional medical image, reducing the workload of a physician, and improving work efficiency.

Furthermore, in the embodiments of the present application, the method can also add at least a portion of the data of the raw three-dimensional medical image to the denoised three-dimensional medical image according to the first operation (e.g., an operation by a physician), thereby enabling restoration of the three-dimensional medical image and thus preserving effective information in the three-dimensional medical image.

In the present application, the method for generating medical images shown in FIG. 1 can be applied to a medical apparatus, which may be a medical imaging device, such as an ultrasound imaging device, a magnetic resonance imaging (MRI) device, or a computer tomography (CT) imaging device. Additionally, the medical apparatus may also be of other types.

The raw three-dimensional (3D) medical image in Operation 101 may be an ultrasound medical image, a magnetic resonance medical image, or a CT medical image. In the following description of the present application, an ultrasound medical image is taken as an example for description, and the description is also applicable to other types of medical images.

In some embodiments of the present application, the raw three-dimensional (3D) medical image in Operation 101 is, for example, a three-dimensional ultrasound medical image. For example, the raw three-dimensional medical image may be a certain three-dimensional medical image frame among a plurality of frames of three-dimensional medical images in a time sequence obtained by performing four-dimensional ultrasound imaging on a subject to be imaged using an ultrasound imaging device.

For example, the data of the raw three-dimensional medical image is three-dimensional imaging data obtained when a gynecological examination is performed on the subject to be imaged. The gynecological examination is, for example, contrast-enhanced ultrasound for the uterus and fallopian tubes, and the data of the raw three-dimensional medical image is, for example, contrast-enhanced ultrasound imaging data for the uterus and fallopian tubes. When hysterosalpingo-contrast sonography (HyCoSy) is performed using an ultrasound imaging device, a contrast agent injected into the vaginal cavity of the subject to be imaged will introduce background noise into the data of the raw three-dimensional medical image. By using the method of the present application, noise in the data of the raw three-dimensional medical image can be efficiently removed, thereby improving the imaging quality and diagnostic efficiency for contrast-enhanced ultrasound of the uterus and fallopian tubes.

In some examples, the data of the raw three-dimensional medical image may be generated based on data acquired by a mechanical scanning ultrasound probe, or the data of the raw three-dimensional medical image may be generated based on data acquired by an electronic scanning ultrasound probe.

For example, when the mechanical scanning ultrasound probe scans a subject under examination (i.e., the subject to be imaged), data (i.e., two-dimensional data) on a plurality of scan planes is acquired by means of mechanical movement (e.g., oscillation) of internal components of the ultrasound probe, and the data of the plurality of scan planes is synthesized to obtain the data of the raw three-dimensional medical image (e.g., data of a three-dimensional ultrasound medical image).

For another example, the electronic scanning ultrasound probe may have array-arranged detection elements; and when the subject under examination (i.e., the subject to be imaged) is scanned, data (i.e., 2D data) on a plurality of scan planes is acquired by controlling detection directions of the detection elements, and the data of the raw three-dimensional medical image (e.g., data of a three-dimensional ultrasound medical image) is obtained.

In the present application, reference may be made to the related art for the process of acquiring the data of the raw three-dimensional medical image, which will not be described in the present application.

In the present application, the data of the raw three-dimensional medical image includes a plurality of pieces of voxel data, where a voxel may be a volume unit in a three-dimensional space, and the size of the volume unit is, for example, related to the resolution of the ultrasound imaging device. Each piece of voxel data may include, for example, position information (e.g., coordinates in the three-dimensional space) of the voxel and imaging information of the voxel (e.g., the imaging information of the voxel may include information such as the brightness, contrast, and pixel values on color channels such as RGB of the voxel).

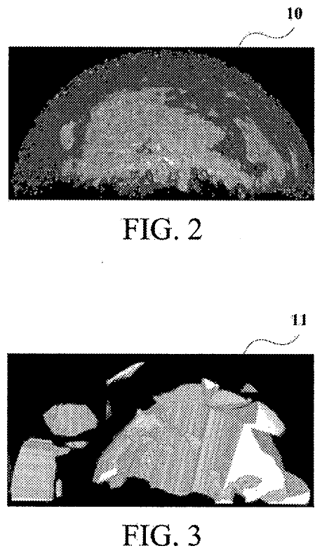

FIG. 2 is a schematic diagram of a raw three-dimensional medical image. For example, data of the raw three-dimensional medical image may drive a display screen, and thus, the raw three-dimensional medical image 10 may be displayed on the display screen. FIG. 2 shows a two-dimensional image presented when the raw three-dimensional medical image 10 is rotated to a certain viewing angle. When the three-dimensional medical image 10 is rotated to another viewing angle, the two-dimensional image presented on the display screen also changes.

In Operation 101 of the present application, the data of the raw three-dimensional medical image is processed to identify the noise-free region in the data of the raw three-dimensional medical image, to obtain the mask data of the noise-free region.

In some examples of Operation 101, the processing may be processing using an artificial intelligence (AI) model or processing using other models. For example, the noise-free region in the data of the raw three-dimensional medical image may be identified based on identification of features related to human organs in the three-dimensional medical image. The type and principle of the model used in the above processing are not specifically defined in the present application. In Operation 101, through the aforementioned processing performed on the data of the raw three-dimensional medical image, the position of the noise-free region in the data of the raw three-dimensional medical image may be determined. For example, the position information of each of the plurality of voxels contained in the noise-free region may be determined. Furthermore, a region in the data of the raw three-dimensional medical image other than the noise-free region can be regarded as a noise region.

In some examples of Operation 101, the mask data of the noise-free region may be set based on the position of the noise-free region. In Operation 101, imaging information of voxels included in the noise-free region may have a first predetermined value, thereby obtaining the mask data of the noise-free region. For example, the brightness, contrast, and pixel values on color channels such as RGB of each voxel in the noise-free region are all set to a maximum value, where when the respective values of the brightness, the contrast, and the pixel values range from 0 to 255, the respective values of the brightness, contrast, pixel values, etc., of each voxel in the noise-free region can be set to 255. Thus, the mask data of the noise-free region can be obtained.

Furthermore, in Operation 101, imaging information of voxels included in the noise region (e.g., the region in the data of the raw three-dimensional medical image other than the noise-free region can be regarded as a noise region) may have a second predetermined value, thereby forming mask data of the noise region. For example, the brightness, contrast, and pixel values on color channels such as RGB of each voxel in the noise region are all set to a minimum value, where when the respective values of brightness, contrast, pixel values, etc., are 0~255, the respective values of the brightness, contrast, pixel values, etc., of each voxel in the noise region can be set to 0. Thus, the mask data of the noise region can be obtained.

FIG. 3 is a schematic diagram of an image corresponding to the mask data of the noise-free region. As shown in FIG. 3, the image corresponding to the mask data of the noise-free region is 11 (i.e., a mask of the noise-free region), where the pixel value of each voxel has a first predetermined value, and each voxel appears as white in the image 11.

In Operation 102 of the present application, the data of the raw three-dimensional medical image is processed according to the mask data of the noise-free region obtained in Operation 101 to generate the data of the denoised three-dimensional medical image.

In some examples, an “XNOR” operation is performed on the data of the raw three-dimensional medical image and the mask data of the noise-free region (e.g., the operator of the “XNOR” operation is denoted as ⊙). For example, an “XNOR” operation is performed on the pixel value of each voxel (e.g., referred to as a first voxel) in the data of the raw three-dimensional medical image and the pixel value of a corresponding voxel (e.g., the position of the corresponding voxel is the same as the position of the first voxel) in the mask data of the noise-free region, thereby obtaining the pixel value of the corresponding voxel in the data of the denoised three-dimensional medical image. Thus, the data of the denoised three-dimensional medical image is generated.

In addition, in Operation 102, the data of the raw three-dimensional medical image can also be processed according to the mask data of the noise region mentioned in the above description to generate data of a three-dimensional medical image reflecting noise. In some examples, an “XNOR” operation is performed on the data of the raw three-dimensional medical image and the mask data of the noise region (e.g., the operator of the “XNOR” operation is denoted as ⊙). For example, an “XNOR” operation is performed on the pixel value of each voxel (e.g., referred to as a first voxel) in the data of the raw three-dimensional medical image and the pixel value of the corresponding voxel (e.g., the position of the corresponding voxel is the same as the position of the first voxel) in the mask data of the noise-free region, thereby obtaining the pixel value of the corresponding voxel in the data of the three-dimensional medical image reflecting noise. Thus, the data of the three-dimensional medical image reflecting noise is generated.

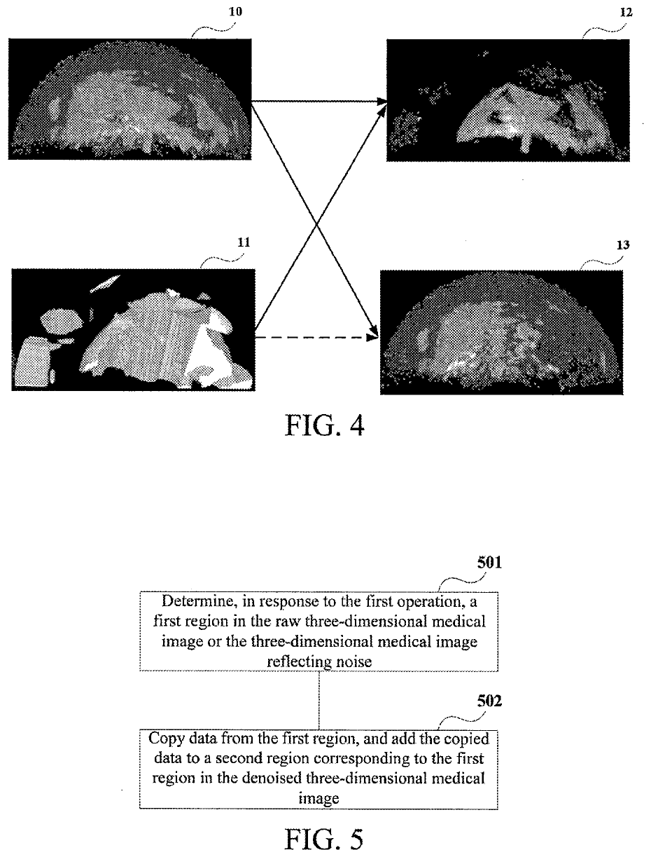

FIG. 4 is a schematic diagram illustrating generation of a denoised three-dimensional medical image and a three-dimensional medical image reflecting noise.

As shown in FIG. 4, data of a denoised three-dimensional medical image (corresponding to a denoised three-dimensional medical image 12) may be generated according to data of a raw three-dimensional medical image (corresponding to the raw three-dimensional medical image 10) and mask data of a noise-free region (corresponding to the image 11).

As shown in FIG. 4, data of a three-dimensional medical image reflecting noise (corresponding to a three-dimensional medical image reflecting noise 13) may be generated according to the data of the raw three-dimensional medical image (corresponding to the raw three-dimensional medical image 10) and mask data of a noise region. The noise-free region may be determined according to the noise region, thereby forming mask data of the noise region, and further generating data of the three-dimensional medical image reflecting noise (corresponding to the three-dimensional medical image reflecting noise 13). Therefore, in FIG. 4, a dashed line connects the mask data of the noise region (corresponding to the image 11) and the data of the three-dimensional medical image reflecting noise (corresponding to the three-dimensional medical image reflecting noise 13).

In some embodiments of the present application, at least one of the denoised three-dimensional medical image 12, the raw three-dimensional medical image 10, and the three-dimensional medical image reflecting noise 13 may be displayed on the display screen, so that the physician may operate these images to obtain a desired image. The operation may be a first operation or a second operation described below.

FIG. 5 is a schematic diagram of processing in response to a first operation, for implementing Operation 103. In some examples of Operation 103, in response to the first operation, the processing method of the present application may add at least a portion of the data of the raw three-dimensional medical image to the data of the denoised three-dimensional medical image. As shown in FIG. 5, the processing in response to the first operation includes:

Operation 501: determining, in response to the first operation, a first region in the raw three-dimensional medical image or the three-dimensional medical image reflecting noise; and

Operation 502: copying data from the first region, and adding the copied data to a second region corresponding to the first region in the denoised three-dimensional medical image.

For example, in Operation 501, the raw three-dimensional medical image 10 or the three-dimensional medical image reflecting noise 13 may be displayed on the display screen. The physician performs the first operation (i.e., a selection operation for the first region in the image) by operating an apparatus such as a mouse, a touch panel, or a track ball, thereby selecting or determining the first region in the raw three-dimensional medical image 10 or the three-dimensional medical image reflecting noise 13. In Operation 502, data (e.g., voxel data) within the first region in the raw three-dimensional medical image 10 or the three-dimensional medical image reflecting noise 13 is copied, and the copied data is added to a second region corresponding to the first region in the denoised three-dimensional medical image 12. The first region selected or determined by the first operation is displayed as a two-dimensional region on the display screen. The two-dimensional region extends in a direction perpendicular to the display plane of the display screen. A region that intersects with the raw three-dimensional medical image 10 or the three-dimensional medical image reflecting noise 13 in a three-dimensional space is the first region in the three-dimensional space. Similarly, the second region is also a region of the denoised three-dimensional medical image 12 in the three-dimensional space.

Through the above processing in response to the first operation, at least a portion of the data can be added to the denoised three-dimensional medical image in the present application, thereby enabling restoration of the three-dimensional medical image and thus preserving effective information in the image. For example, in a case where some effective information in the raw three-dimensional medical image 10 is mistakenly removed through Operation 102, the physician can restore the effective information through Operation 103, causing the effective information to be displayed in the denoised three-dimensional medical image 12.

Furthermore, in some examples, in Operation 501, the first region selected or determined by the first operation may be the entire region of the raw three-dimensional medical image 10 or the three-dimensional medical image reflecting noise 13. In Operation 502, all data (e.g., voxel data) in the raw three-dimensional medical image 10 or the three-dimensional medical image reflecting noise 13 is copied, and the copied data is added to the denoised three-dimensional medical image 12. In this example, the first operation may be clicking a preset button on a display screen, where the name of the preset button is, for example, “Restore to Raw Image,” etc. Thus, via the first operation, the physician may cancel or discard a denoising processing result (i.e., a processing result of Operation 102) for the raw three-dimensional medical image 10.

As shown in FIG. 1, some embodiments of the method for processing medical images may further include Operation 104:

Operation 104: clearing, in response to a second operation, data of at least a partial region of the denoised three-dimensional medical image.

For example, in Operation 104, the denoised three-dimensional medical image 12 obtained after the processing of Operation 102 may be displayed on the display screen, and the physician may perform the second operation (i.e., selecting a third region in the denoised three-dimensional medical image 12) by operating an apparatus such as a mouse, touch panel, or track ball, thereby selecting or determining the third region in the denoised three-dimensional medical image 12; and then the data (e.g., voxel data) in the third region is removed from the data of the denoised three-dimensional medical image 12.

After Operation 104, the denoised three-dimensional medical image 12 no longer includes or displays the third region. Thus, the physician can use Operation 104 to further adjust the denoised three-dimensional medical image 12 generated in Operation 102 to remove residual noise.

In the present application, the physician may perform the first operation or the second operation as needed, thereby further adjusting the denoised three-dimensional medical image 12 generated in Operation 102, for example, further removing residual noise from the denoised three-dimensional medical image 12, or adding a portion of data in the raw three-dimensional medical image 10 or the three-dimensional medical image reflecting noise 13 to the denoised three-dimensional medical image 12.

As shown in FIG. 1, some embodiments of the method for processing medical images may further include Operation 105:

Operation 105: selecting, in response to a third operation, one model from two or more models for performing the processing in Operation 101.

In Operation 101, a model (e.g., an artificial intelligence model or another model) may be used to process the data of the raw three-dimensional medical image to obtain the mask data of the noise-free region. The model used in Operation 101 may be a default model, or may be a model selected from two or more models through Operation 105. Among the two or more models, the denoising effects corresponding to respective models may be different from each other, for example: the mask data of the noise-free region generated based on model 1 may encompass a larger noise-free region, thereby resulting in a stronger denoising effect on the data of the raw three-dimensional medical image, i.e., the data of the denoised three-dimensional medical image contains less voxel data; while the mask data of the noise-free region generated based on model 2 may encompass a smaller noise-free region, thereby resulting in a weaker denoising effect on the data of the raw three-dimensional medical image, i.e., the data of the denoised three-dimensional medical image retains more voxel data. Thus, through Operation 105, the physician can select a corresponding model to obtain a desired denoising effect.

Regarding the third operation in Operation 105, for example, the third operation may be: the physician may perform an operation (i.e., the third operation) such as pressing, toggling, clicking, or dragging on a physical key on the medical apparatus or a button or icon displayed on a user interface (UI), to select a model from the two or more models to generate the mask data of the noise-free region.

In some examples, the physical button or the button or icon displayed on the user interface (UI) may be marked with name or number information of the model (e.g., the UI displays respective icons of a plurality of models, and each icon is marked with name or number information of the model, etc.), or the physical button or the button or icon displayed on the user interface (UI) may be marked with information such as a denoising effect corresponding to the model (e.g., the UI displays respective icons of a plurality of models, and each icon is marked with a denoising effect corresponding to the model, such as “strong denoising effect”, “moderate denoising effect”, and “weak denoising effect”), thereby facilitating the physician to confirm the model that needs to be selected.

As shown in FIG. 1, some embodiments of the method for processing medical images may further include Operation 106:

Operation 106: displaying the raw three-dimensional medical image or the three-dimensional medical image reflecting noise, and the denoised three-dimensional medical image independently of each other on the display screen; or displaying the raw three-dimensional medical image or the three-dimensional medical image reflecting noise, and the denoised three-dimensional medical image in a linked manner on the display screen.

In some examples of Operation 106, the raw three-dimensional medical image or the three-dimensional medical image reflecting noise, and the denoised three-dimensional medical image are displayed independently of each other on the display screen.

As an example, the raw three-dimensional medical image 10 and the denoised three-dimensional medical image 12 are respectively displayed in different regions of the same display screen, and display information (e.g., at least one of rotation direction, position, and size) of the two does not change synchronously. That is, when the physician performs an operation such as rotation, scaling, or position adjustment on one of the two to adjust the display information thereof, the display information of the other does not change accordingly.

As another example, the three-dimensional medical image reflecting noise 13 and the denoised three-dimensional medical image 12 are respectively displayed in different regions of the same display screen, and the display information (e.g., the display information includes at least one of the rotation direction of the image, the position of the image, and the size of the image) of the two does not change synchronously. That is, when the physician performs an operation such as rotation, scaling, or position adjustment on one of the two to adjusts the display information thereof, the display information of the other does not change accordingly.

As a further example, in one display screen, only one of the raw three-dimensional medical image 10, the three-dimensional medical image reflecting noise 13, and the denoised three-dimensional medical image 12 is displayed at one moment, and the physician performs a switching operation to cause the display screen to display the raw three-dimensional medical image 10, the three-dimensional medical image reflecting noise 13, or the denoised three-dimensional medical image 12 in turn. Additionally, in a case where the physician performs an operation such as rotation, scaling, or position adjustment on a currently displayed image on the display screen to adjust the display information thereof, the operation only acts on the currently displayed image. That is, when switching to display another image, the display information of that other image remains as it was before the operation.

In other examples of Operation 106, the raw three-dimensional medical image or the three-dimensional medical image reflecting noise, and the denoised three-dimensional medical image are displayed in a linked manner on the display screen. Thus, it is convenient for the physician to comparatively observe the raw three-dimensional medical image or the three-dimensional medical image reflecting noise, and the denoised three-dimensional medical image, which is beneficial for more accurately obtaining information in the images.

For example, the raw three-dimensional medical image 10 or the three-dimensional medical image reflecting noise 13 is displayed in a first display region of the display screen, and the denoised three-dimensional medical image 12 is displayed (e.g., simultaneously displayed) in a second display region of the display screen, where the first display region and the second display region may be in the same display screen or in different display screens; and the three-dimensional medical image in the first display region (e.g., the raw three-dimensional medical image 10 or the three-dimensional medical image reflecting noise 13) and the three-dimensional medical image in the second display region (e.g., the denoised three-dimensional medical image 12) have identical display information (e.g., the display information includes at least one of the rotation direction of the image, the position of the image, and the size of the image).

In Operation 106, in a case where the raw three-dimensional medical image or the three-dimensional medical image reflecting noise, and the denoised three-dimensional medical image are displayed in a linked manner on the display screen, when the display information of the three-dimensional medical image in one of the first display region and the second display region changes, the display information of the three-dimensional medical image in the other display region changes in the same manner. For example, the raw three-dimensional medical image 10 is displayed in the first display region of the display screen, while the denoised three-dimensional medical image 12 is simultaneously displayed in the second display region of the display screen. When the physician performs an operation such as rotation, scaling, or position adjustment on the raw three-dimensional medical image 10 in the first display region to adjust the display information thereof, this operation also acts on the denoised three-dimensional medical image 12 in the second display region. That is, the display information of the raw three-dimensional medical image 10 in the first display region and the display information of the denoised three-dimensional medical image 12 in the second display region are both adjusted in the same manner by the operation. Consequently, the three-dimensional images in the first display region and the second display region can be displayed in a linked manner.

In Operation 106, in a case where the raw three-dimensional medical image or the three-dimensional medical image reflecting noise, and the denoised three-dimensional medical image are displayed in a linked manner on the display screen, in some specific implementations, when display control is performed, control information generated by an operation performed by the physician on either the first display region or the second display region for changing the display information of the three-dimensional image can be transmitted to the other of the first display region and the second display region. Thus, the display information of the three-dimensional images in the first display region and the second display region can be synchronously adjusted. Moreover, the present application is not limited thereto, and other implementations can also be used to display the raw three-dimensional medical image or the three-dimensional medical image reflecting noise, and the denoised three-dimensional medical image in a linked manner on the display screen.

In Operation 106 of the present application, in a case where the raw three-dimensional medical image or the three-dimensional medical image reflecting noise, and the denoised three-dimensional medical image are displayed in a linked manner on the display screen, the linked display of the three-dimensional medical images in the first display region and the second display region can be incorporated to implement Operation 103. The linked display manner ensures that the three-dimensional medical images in the two regions always maintain a correspondence. In other words, the data cleared from the three-dimensional image in one region can be returned to the three-dimensional image in the other region accordingly, and data addition in one region and data subtraction in the other region correspond to each other in position (e.g., the coordinates of one region where the data subtracted in that region is located are consistent with the coordinates of the other region where the data added in that region is located). Therefore, it is beneficial for the physician to determine whether to subsequently delete or add data.

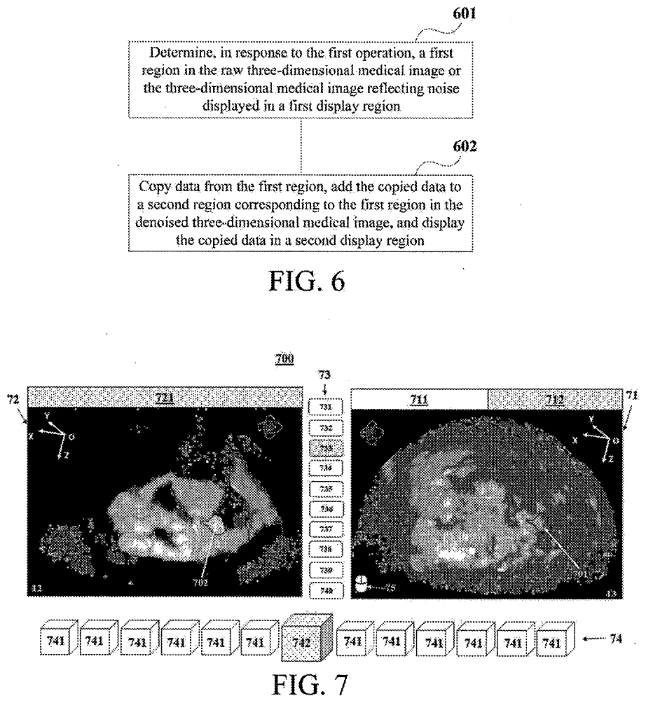

FIG. 6 is a schematic diagram of the processing in response to the first operation in a case where the three-dimensional medical images are displayed in a linked manner in the first display region and the second display region, for implementing Operation 103. As shown in FIG. 6, the processing includes:
601: determining, in response to the first operation, a first region in the raw three-dimensional medical image or the three-dimensional medical image reflecting noise displayed in the first display region; and
602: copying data from the first region, adding the copied data to a second region corresponding to the first region in the denoised three-dimensional medical image, and displaying the copied data in the second display region.

Thus, the physician can perform the first operation while comparatively observing the three-dimensional medical image in the first display region and the three-dimensional medical image in the second display region, thereby improving the accuracy of the first operation and more accurately restoring effective information to the denoised three-dimensional medical image.

In Operation 106 of the present application, in a case where the raw three-dimensional medical image or the three-dimensional medical image reflecting noise, and the denoised three-dimensional medical image are displayed in a linked manner on the display screen, the linked display of the three-dimensional medical images in the first display region and the second display region can be incorporated to implement Operation 104.

For example, when data of at least a partial region of the denoised three-dimensional medical image 12 is cleared in response to the second operation, the at least a partial region corresponding to the cleared data is displayed in the first display region and the second display region. Thus, the physician can perform the second operation while comparatively observing the three-dimensional medical image in the first display region and the three-dimensional medical image in the second display region, thereby facilitating confirmation of the corresponding position of the data cleared from the denoised three-dimensional medical image 12 in the raw three-dimensional medical image 10 or the three-dimensional medical image reflecting noise 13, and avoiding erroneously clearing data. Moreover, in the present application, the at least a partial region corresponding to the data cleared by the second operation may also be displayed only in the first display region without being displayed in the second display region.

The method for implementing Operation 103 or Operation 104 by incorporating the linked display of the three-dimensional medical images in the first display region and the second display region is described below with reference to specific drawings.

FIG. 7 is a schematic diagram of the display screen when the three-dimensional medical images are displayed in a linked manner in the first display region and the second display region, for illustrating an implementation of Operation 103.

In the example shown in FIG. 7, a user interface 700 displayed on the display screen includes a first display region 71 and a second display region 72. The first display region 71 and the second display region 72 may be arranged side by side (left and right) or one above the other (up and down) on the user interface 700, which is not specifically defined in the present application.

The raw three-dimensional medical image 10 or the three-dimensional medical image reflecting noise 13 may be displayed in the first display region 71. Display tabs 711 and 712 may be provided near the first display region 71 (e.g., above the first display region 71) to respectively label the types of images displayed in the first display region 71, where the display tab 711 may correspond to the raw three-dimensional medical image 10, and the display tab 712 may correspond to the three-dimensional medical image reflecting noise 13. The physician may perform a selection operation (e.g., clicking the corresponding label) to select the display tab 711 or 712, thereby displaying the raw three-dimensional medical image 10 or the three-dimensional medical image reflecting noise 13 in the first display region 71. Furthermore, the selected display tab 711 or 712 may be emphasized (e.g., highlighted) to indicate that the display tab is selected.

For example, in the example shown in FIG. 7, the display tab 712 is highlighted, and the three-dimensional medical image reflecting noise 13 is displayed in the first display region 71.

As shown in FIG. 7, the denoised three-dimensional medical image 12 may be displayed in the second display region 72. The display tab 721 may be provided near the second display region 72 (e.g., above the second display region 72) to label that the type of the image displayed in the second display region 72 is the denoised three-dimensional medical image 12. The display tab 721 may be emphasized (e.g., highlighted).

As shown in FIG. 7, the three-dimensional medical image reflecting noise 13 and the denoised three-dimensional medical image 12 are displayed on the display screen in a linked manner. The three-dimensional medical image reflecting noise 13 in the first display region 71 and the denoised three-dimensional medical image 12 in the second display region 72 have identical display information (e.g., the display information includes at least one of the rotation direction of the image, the position of the image, and the size of the image).

For example, coordinate axes of a three-dimensional coordinate system displayed in the first display region 71 (e.g., the three-dimensional coordinate system in which the three-dimensional medical image reflecting noise 13 resides, which may be an anatomical coordinate system or a world coordinate system) and coordinate axes of a three-dimensional coordinate system displayed in the second display region 72 (e.g., the three-dimensional coordinate system in which the denoised three-dimensional medical image 12 resides, which may be an anatomical coordinate system or a world coordinate system) have consistent orientations for the corresponding axes. That is, the X-axis displayed in the first display region 71 is directionally consistent with the X-axis displayed in the second display region 72, the Y-axis displayed in the first display region 71 is directionally consistent with the Y-axis displayed in the second display region 72, and the Z-axis displayed in the first display region 71 is directionally consistent with the Z-axis displayed in the second display region 72.

In the example shown in FIG. 7, when the physician performs operations such as rotation, scaling, or position adjustment on one of the three-dimensional medical images (e.g., the three-dimensional medical image reflecting noise 13) to adjust the display information thereof, the display information of the other three-dimensional medical image (e.g., the denoised three-dimensional medical image 12) changes in the same manner.

In the example shown in FIG. 7, the user interface 700 may further include a toolbar 73 and an image frame selection region 74.

In some examples, the toolbar 73 may be disposed between the first display region 73 and the second display region 72, or may be disposed at other positions. The toolbar 73 may be provided with a plurality of buttons, and the physician can select a corresponding button to activate a corresponding function. For example, the plurality of buttons may include at least one of the following buttons:
add circular region 731, i.e., in the first operation, allowing the physician to select a circular region as the first region;
add polygonal region 732, i.e., in the first operation, allowing the physician to select a polygonal region as the first region;
add freehand-drawn region 733, i.e., in the first operation, allowing the physician to use a freely drawn closed region as the first region;
add circular region 734, i.e., in the second operation, allowing the physician to select a circular region and clear data in the circular region;
add polygonal region 735, i.e., in the first operation, allowing the physician to select a polygonal region and clear data in the polygonal region;
add freehand-drawn region 736, i.e., in the first operation, allowing the physician to freely draw a closed region and clear data in this region;
apply to single 737, i.e., applying the first operation or second operation for the current frame only to the data of the denoised three-dimensional medical image corresponding to the current frame;
apply to loop 738, i.e., applying the first operation or second operation for the current frame to the data of the denoised three-dimensional medical image corresponding to each of a plurality of frames of images in a time sequence to which the current frame belongs;
save single 739, i.e., saving the processing result of the first operation or second operation for the current frame into the data of the denoised three-dimensional medical image of the current frame;
save loop 740, i.e., applying the first operation or second operation for the current frame to each of a plurality of frames of images in a time sequence to which the current frame belongs, and saving the result into the data of the denoised three-dimensional medical image corresponding to each frame.

In the example shown in FIG. 7, the image frame selection region 74 may be provided below the first display region 71 and the second display region 72, or may be provided at other positions. A plurality of image frame icons 741 may be displayed in the image frame selection region 74, and the plurality of image frame icons 741 may be arranged in a time sequence. The physician may select one of the image frame icons as a current image frame icon 742, where the current image frame icon 742 may be emphasized relative to the other unselected image frame icons 741 (e.g., the current image frame icon 742 may be enlarged or highlighted), and the raw three-dimensional medical image 10 or the three-dimensional medical image reflecting noise 13 corresponding to the current image frame icon 742 may be displayed in the first display region 71, and the denoised three-dimensional medical image 12 corresponding to the current image frame icon 742 may be displayed in the second display region 72.

As shown in FIG. 7, the three-dimensional medical image reflecting noise 13 in the first display region 71 and the denoised three-dimensional medical image 12 in the second display region 72 are displayed in a linked manner on the display screen. After the physician selects one of the buttons 731 to 733 in the toolbar 73 (e.g., selects the button 733), the physician performs a selection operation (i.e., the first operation) in the three-dimensional medical image reflecting noise 13 displayed in the first display region 71 to select the first region 701. The data (e.g., voxel data) in the first region 701 in the three-dimensional medical image reflecting noise 13 is copied, the copied data is added to the second region 702 corresponding to the first region 701 in the denoised three-dimensional medical image 12, and the data copied to the second region 702 is displayed in the second display region 72.

Furthermore, in FIG. 7, when the physician performs a selection operation (i.e., the first operation) in the three-dimensional medical image reflecting noise 13 displayed in the first display region 71, an operation indication icon 75 may be displayed in the first display region 71, and the operation indication icon 75 is used to indicate that the physician is performing a selection operation in the first display region 71. In some other cases, when the physician performs a selection operation in the second display region 72, the operation indication icon 75 may be displayed in the second display region 72.

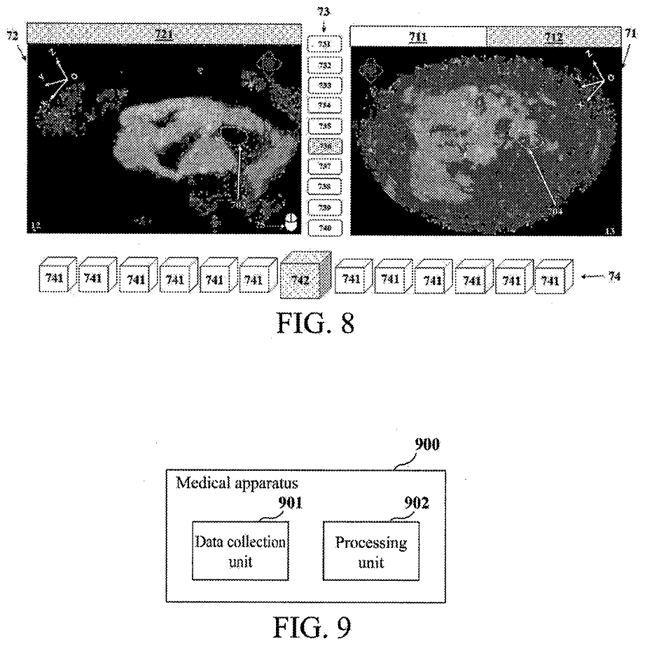

FIG. 8 is another schematic diagram of the display screen when the three-dimensional medical images are displayed in a linked manner in the first display region and the second display region, for illustrating an implementation of Operation 104. The same reference numerals in FIG. 8 as those in FIG. 7 have the same meanings, and will not be described again.

In the example shown in FIG. 8, the three-dimensional medical image reflecting noise 13 in the first display region 71 and the denoised three-dimensional medical image 12 in the second display region 72 are displayed in a linked manner on the display screen. After the physician selects one of the buttons 734 to 736 in the toolbar 73 (e.g., selects the button 736), the physician performs a selection operation (i.e., the second operation) in the denoised three-dimensional medical image 12 displayed in the second display region 72 to select a third region 703; then, data (e.g., voxel data) in the third region 703 in the denoised three-dimensional medical image 12 is cleared, i.e., the denoised three-dimensional medical image 12 no longer displays an image corresponding to the data in the third region 703. In some examples, a region 704 corresponding to the third region 703 may be displayed on the three-dimensional medical image reflecting noise 13 in the first display region 71 to facilitate confirmation by the physician. Furthermore, the present application is not limited thereto. For example, the region 704 may not be marked on the three-dimensional medical image reflecting noise 13 in the first display region 71.

In FIG. 8, when the physician performs a selection operation (i.e., the second operation) in the denoised three-dimensional medical image 12 displayed in the second display region 72, the operation indication icon 75 may be displayed in the second display region 72.

Some embodiments of the present application further provide a medical apparatus.

FIG. 9 is a schematic diagram of a medical apparatus according to an embodiment of the present application.

As shown in FIG. 9, the medical apparatus 900 includes:
image; and
a data collection unit 901 that collects data of a raw three-dimensional medical
a processing unit 902 that executes the method for processing medical images as shown in FIG. 1.

In some embodiments, the method for processing medical images includes:
processing data of a raw three-dimensional medical image to obtain mask data of a noise-free region;
processing the data of the raw three-dimensional medical image according to the mask data of the noise-free region to generate data of a denoised three-dimensional medical image; and
adding, in response to a first operation, at least a portion of the data of the raw three-dimensional medical image to the data of the denoised three-dimensional medical image.

In some examples, the data of the raw three-dimensional medical image is contrast-enhanced ultrasound imaging data for the uterus and fallopian tubes.

In some examples, adding, in response to a first operation, at least a portion of the data of the raw three-dimensional medical image to the data of the denoised three-dimensional medical image includes:
determining, in response to the first operation, a first region in the raw three-dimensional medical image or a three-dimensional medical image reflecting noise; and
copying data from the first region, and adding the copied data to a second region corresponding to the first region in the denoised three-dimensional medical image.

In some examples, the method further includes:
clearing, in response to a second operation, data of at least a partial region of the denoised three-dimensional medical image.

In some examples, the method further includes:
selecting, in response to a third operation, one model from two or more models for performing the processing to obtain the mask data of the noise-free region.

In some examples, the method further includes:
displaying the raw three-dimensional medical image or a three-dimensional medical image reflecting noise, and the denoised three-dimensional medical image independently of each other on a display screen; or
displaying the raw three-dimensional medical image or a three-dimensional medical image reflecting noise, and the denoised three-dimensional medical image in a linked manner on a display screen.

In some examples, displaying the raw three-dimensional medical image or a three-dimensional medical image reflecting noise, and the denoised three-dimensional medical image in a linked manner on a display screen includes:
displaying the raw three-dimensional medical image or the three-dimensional medical image reflecting noise in a first display region of the display screen, and displaying the denoised three-dimensional medical image in a second display region of the display screen, the three-dimensional medical image in the first display region and the three-dimensional medical image in the second display region having identical display information, where when the display information of the three-dimensional medical image in one of the display regions changes, the display information of the three-dimensional medical image in the other display region changes in the same manner.

In some examples, adding, in response to a first operation, at least a portion of the data of the raw three-dimensional medical image to the denoised three-dimensional medical image includes:
determining, in response to the first operation, a first region in the raw three-dimensional medical image or the three-dimensional medical image reflecting noise displayed in the first display region; and
copying data from the first region, adding the copied data to a second region corresponding to the first region in the denoised three-dimensional medical image, and displaying the copied data in the second display region.

In some examples, when data of at least a partial region of the denoised three-dimensional medical image is cleared in response to a second operation, the at least a partial region corresponding to the cleared data is displayed in the first display region and the second display region.

For further description of each unit in the medical apparatus 900, reference may be made to a detailed description of a corresponding operation in FIG. 1.

It can be understood that the medical apparatus 900 may include different types, and for example, the medical apparatus may be a medical imaging system, such as an ultrasound imaging system, a magnetic resonance imaging (MRI) system, or a computed tomography (CT) imaging system. The following is described by taking an example in which the medical apparatus 900 is an ultrasound imaging system.

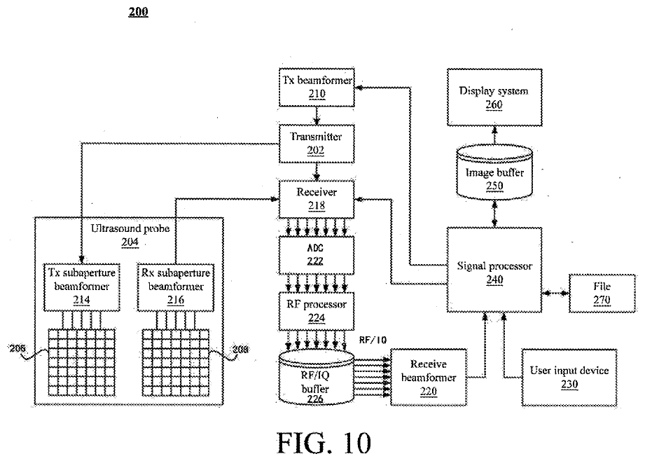

FIG. 10 is a schematic diagram of an ultrasound imaging system according to an embodiment of the present application. As shown in FIG. 10, the ultrasound imaging system 200 may be configured to provide ultrasound imaging, and thus may include suitable circuitry, interfaces, logic, and/or code for executing and/or supporting ultrasound imaging-related functions.

The ultrasound imaging system 200 includes, for example, a transmitter 202, an ultrasound probe 204 (corresponding to the foregoing scanning device), a transmit beamformer 210, a receiver 218, a receive beamformer 220, an RF processor 224, an RF/IQ buffer 226, a user input module 230, a signal processor 240 (corresponding to the foregoing processor 114), an image buffer 250, a display system 260 (a display), and a file 270.

The transmitter 202 may include suitable circuitry, interfaces, logic, and/or code operable to drive the ultrasound probe 204. The ultrasound probe 204 may include an array of two-dimensional (2D) piezoelectric elements. The ultrasound probe 204 may include a set of transmit transducer elements 206 and a set of receive transducer elements 208 that typically form the same element. In some embodiments, the ultrasound probe 204 may be operable to acquire ultrasound image data covering at least a substantial portion of an anatomical structure (such as the heart or any suitable anatomical structure). The ultrasound probe 204 may be an electronic scanning ultrasound probe or a mechanical scanning ultrasound probe.

The transmit beamformer 210 may include suitable circuitry, interfaces, logic, and/or code that is operable to control the transmitter 202, and the transmitter 202 drives the set of transmit transducer elements 206 by means of a transmit subaperture beamformer 214 to transmit ultrasound emission signals into a region of interest (e.g., a person, animal, subsurface cavity, physical structure, etc.). The emitted ultrasound signal can be backscattered from structures (e.g., blood cells or tissue) in a subject of interest to produce echoes. The echoes are received by the receive transducer elements 208.

The set of receive transducer elements 208 in the ultrasound probe 204 is operable to convert the received echoes to analog signals for subaperture beam formation by means of a receiving subaperture beamformer 216, which are then transmitted to the receiver 218. The receiver 218 may include suitable circuitry, interfaces, logic, and/or code that is operable to receive signals from the receiving subaperture beamformer 216. The analog signals can be transferred to one or more of a plurality of A/D converters 222.

The plurality of A/D converters 222 may include suitable circuitry, interfaces, logic, and/or code that is operable to convert each analog signal from the receiver 218 to a corresponding digital signal. The plurality of A/D converters 222 are provided between the receiver 218 and the RF processor 224. Nevertheless, the present application is not limited in this regard. Thus, in some embodiments, the plurality of A/D converters 222 may be integrated within the receiver 218.

The RF processor 224 may include suitable circuitry, interfaces, logic, and/or code that is operable to demodulate the digital signals outputted by the plurality of A/D converters 222. According to one embodiment, the RF processor 224 may include a complex demodulator (not shown) that is operable to demodulate each digital signal to form an I/Q data pair representing the corresponding echo signal. The RF or I/Q signal data can then be transferred to the RF/IQ buffer 226. The RF/IQ buffer 226 may include suitable circuitry, interfaces, logic, and/or code that is operable to provide temporary storage of RF or I/Q signal data generated by the RF processor 224.

The receive beamformer 220 may include suitable circuitry, interfaces, logic, and/or code that may be operable to execute digital beamforming processing to, for example, sum delay-channel signals received from the RF processor 224 via the RF/IQ buffer 226 and output a beam summing signal. The resulting processed information may be the beam summing signal outputted from the receive beamformer 220 and transmitted to the signal processor 240. According to some embodiments, the receiver 218, the plurality of A/D converters 222, the RF processor 224, and the beamformer 220 may be integrated into a single beamformer which may be digital. In various embodiments, the ultrasound imaging system 200 includes a plurality of receive beamformers 220.

The user input device 230 can be used to enter patient data, scan parameters, and settings, and select protocols and/or templates to interact with an artificial intelligence segmentation processor, so as to select tracking targets, etc. In an illustrative embodiment, the user input device 230 is operable to configure, manage, and/or control the operation of one or more components and/or modules in the ultrasound imaging system 200. In this regard, the user input device 230 is operable to configure, manage, and/or control the operation of the transmitter 202, the ultrasound probe 204, the transmit beamformer 210, the receiver 218, the receive beamformer 220, the RF processor 224, the RF/IQ buffer 226, the user input device 230, the signal processor 240, the image buffer 250, the display system 260, and/or the file 270.

For example, user input devices 230 may include buttons, rotary encoders, touch screens, motion tracking, voice recognition, mouse devices, keyboards, track balls, cameras, and/or any other devices capable of receiving user commands. In some embodiments, for example, one or more of the user input devices 230 may be integrated into other components (such as the display system 260 or the ultrasound probe 204). As an example, the user input device 230 may include a touch screen display. As another example, the user input device 230 may include an accelerometer, gyroscope, and/or magnetometer attached to and/or integrated with the probe 204 to provide pose and motion recognition of the probe 204, such as identifying one or more probe compressions against the patient's body, predefined probe movements, or tilt operations, etc. Additionally and/or alternatively, the user input device 230 may include image analysis processing to identify the probe pose by analyzing the acquired image data.

Furthermore, in the present application, the user (e.g., the physician) may perform at least one of the first operation, the second operation, and the third operation mentioned above, selection of tabs in the toolbar 73, selection of the current image frame icon 742, etc., using the input device 230.

The signal processor 240 may include suitable circuitry, interfaces, logic, and/or code that is operable to process the ultrasound scan data (i.e., the summed IQ signal) to generate an ultrasound image for presentation on the display system 260. The signal processor 240 is operable to execute one or more processing operations based on a plurality of selectable ultrasound modalities on the acquired ultrasound scan data. In an illustrative embodiment, the signal processor 240 is operable to execute display processing and/or control processing, etc. As the echo signals are received, the acquired ultrasound scan data can be processed in real-time during the scan session. Additionally or alternatively, the ultrasound scan data may be temporarily stored in the RF/IQ buffer 226 during the scan session and processed in a less real-time manner during online or offline operation. In various embodiments, the processed image data may be presented at the display system 260 and/or may be stored in the file 270. The file 270 can be a local file, a picture archiving and communication system (PACS), or any suitable device for storing images and related information.

The signal processor 240 may be one or more central processing units, microprocessors, microcontrollers, etc. For example, the signal processor 240 may be an integrated component, or may be distributed in various locations. The signal processor 240 may be configured to receive input information from the user input device 230 and/or file 270, generate outputs that may be shown by the display system 260, and manipulate the outputs, etc., in response to the input information from the user input device 230. The signal processor 240 may be capable of executing, for example, any of one or more of the methods and/or one or more sets of instructions discussed herein according to various embodiments.

In some embodiments of the ultrasound imaging system 200, the signal processor 240 can be configured to implement the functions of the data collection unit 901 and the processing unit 902 in FIG. 9, so as to execute the method for processing medical images described in the foregoing embodiments of the present application. For example, the signal processor 240 receives data from the receive beamformer 220, and generates data of a raw three-dimensional medical image based on the received data. Further, the signal processor 240 processes the data of the raw three-dimensional medical image to obtain mask data of a noise-free region, processes the data of the raw three-dimensional medical image according to the mask data of the noise-free region to generate data of a denoised three-dimensional medical image, and then adds, in response to a first operation, at least a portion of the data of the raw three-dimensional medical image to the data of the denoised three-dimensional medical image. Furthermore, the signal processor 240 may further be configured to: display the raw three-dimensional medical image or a three-dimensional medical image reflecting noise, and the denoised three-dimensional medical image independently of each other on a display screen of the display system 260; or display the raw three-dimensional medical image or a three-dimensional medical image reflecting noise, and the denoised three-dimensional medical image in a linked manner on a display screen of the display system 260. For a detailed description of the method for processing medical images, reference may be made to the related descriptions of the foregoing embodiments.

The ultrasound imaging system 200 may be operated to continuously acquire ultrasound scan data at a frame rate suitable for the imaging situation under consideration. Typical frame rates are in the range of 20 to 220, but can be lower or higher. The acquired ultrasound scan data can be shown on the display system 260 in real-time at a display rate that is the same as the frame rate, or slower, or faster than the frame rate. The image buffer 250 is included to store processed frames of the acquired ultrasound scan data that are not scheduled for immediate display. Preferably, the image buffer 250 has sufficient capacity to store frames of ultrasound scan data for at least a few minutes. Frames of ultrasound scan data are stored in such a way that the same can be easily retrieved therefrom according to the acquisition sequence or time thereof. The image buffer 250 may be embodied in any known data storage medium.

In some specific embodiments, the signal processor 240 may be configured to execute or otherwise control at least some of the functions executed thereby based on user instructions via the user input device 230. As an example, a user may provide voice commands, probe poses, button presses, etc., to issue specific commands, such as controlling aspects of automatic strain measurement and strain ratio calculations, and/or providing or otherwise specifying various parameters or settings associated therewith, as described in more detail below.

In operation, the ultrasound imaging system 200 may be used to generate ultrasound images, including two-dimensional (2D), three-dimensional (3D), and/or four-dimensional (4D) images. In this regard, the ultrasound imaging system 200 may be operated to continuously acquire ultrasound scan data at a specific frame rate, which may be applicable to the imaging situation discussed. For example, the frame rate can be within the range of 20-70, or can be lower or higher. The acquired ultrasound scan data can be shown on the display system 260 at the same display rate as the frame rate, or slower or faster than the frame rate. The image buffer 250 is included to store processed frames of the acquired ultrasound scan data that are not scheduled for immediate display. Preferably, the image buffer 250 has sufficient capacity to store frames of ultrasound scan data for at least a few seconds. Frames of ultrasound scan data are stored in such a way that the same can be easily retrieved therefrom according to the acquisition sequence or time thereof. The image buffer 250 may be embodied in any known data storage medium.

In some cases, the ultrasound imaging system 200 may be configured to support grayscale and color-based operations. For example, the signal processor 240 may be operable to execute grayscale B-model processing and/or color processing. Grayscale B-model processing may include processing B-model RF signal data or IQ data pairs. For example, the grayscale B-model processing can enable the formation of an envelope of the beam-summed received signal by computing the amount (I²+Q²)^{1/2}. The envelope can be subjected to additional B-model processing, such as logarithmic compression to form display data. The display data can be converted to an X-Y format for video display. Scan-converted frames can be mapped to grayscale for display. B-model frames are provided to the image buffer 250 and/or the display system 260. Color processing may include processing color-based RF signal data or IQ data pairs to form frames to cover the B-model frames provided to image buffer 250 and/or display system 260. Grayscale and/or color processing may be self-adaptively adjusted based on user input (e.g., selections from the user input device 230), such as for enhancing the grayscale and/or color of a particular region.

The embodiments of the present application further provide a computer-readable program. The program, when executed, causes a computer to execute, in a medical imaging system, the method for processing medical images as described in any of the foregoing embodiments.

The embodiments of the present application further provide a storage medium storing a computer-readable program. The computer-readable program causes a computer to execute, in a medical imaging system, the method for processing medical images as described in any of the foregoing embodiments.

A non-transitory computer-readable medium stores a computer program. The computer program has at least one code segment, and the at least one code segment is executable by a machine (e.g., a computer) to cause the machine to execute the method for processing medical images as described in any of the foregoing embodiments.

The above embodiments merely provide illustrative descriptions of the embodiments of the present application. However, the present application is not limited thereto, and suitable variations may be made on the basis of the above embodiments. For example, each of the above embodiments may be used independently, or one or more of the above embodiments may be combined.

The present application is described above with reference to specific implementations. However, it should be clear to those skilled in the art that the foregoing description is merely illustrative and is not intended to limit the scope of protection of the present application. Various variations and modifications may be made by those skilled in the art according to the spirit and principle of the present application, and these variations and modifications also fall within the scope of the present application.

Preferred implementations of the present application are described above with reference to the accompanying drawings. Many features and advantages of the implementations are clear according to the detailed description. Therefore, the appended claims are intended to cover all these features and advantages that fall within the true spirit and scope of these implementations. In addition, as many modifications and changes could be easily conceived of by those skilled in the art, the implementations of the present application are not limited to the illustrated and described precise structures and operations, but can encompass all appropriate modifications, changes, and equivalents that fall within the scope of the implementations.

What is claimed is:

1. A method for processing medical images, comprising:
processing data of a raw three-dimensional medical image to obtain mask data of a noise-free region;
processing the data of the raw three-dimensional medical image according to the mask data of the noise-free region to generate data of a denoised three-dimensional medical image; and
adding, in response to a first operation, at least a portion of the data of the raw three-dimensional medical image to the data of the denoised three-dimensional medical image.

2. The method according to claim 1, wherein
the data of the raw three-dimensional medical image is contrast-enhanced ultrasound imaging data for the uterus and fallopian tubes.

3. The method according to claim 1, wherein
adding, in response to a first operation, at least a portion of the data of the raw three-dimensional medical image to the data of the denoised three-dimensional medical image comprises:
determining, in response to the first operation, a first region in the raw three-dimensional medical image or a three-dimensional medical image reflecting noise; and
copying data from the first region, and adding the copied data to a second region corresponding to the first region in the denoised three-dimensional medical image.

4. The method according to claim 1, further comprising:
clearing, in response to a second operation, data of at least a partial region of the denoised three-dimensional medical image.

5. The method according to claim 1, further comprising:
selecting, in response to a third operation, one model from two or more models for performing the processing.

6. The method according to claim 1, further comprising:
displaying the raw three-dimensional medical image or a three-dimensional medical image reflecting noise, and the denoised three-dimensional medical image independently of each other on a display screen; or
displaying the raw three-dimensional medical image or a three-dimensional medical image reflecting noise, and the denoised three-dimensional medical image in a linked manner on a display screen.

7. The method according to claim 6, wherein
displaying the raw three-dimensional medical image or a three-dimensional medical image reflecting noise, and the denoised three-dimensional medical image in a linked manner on a display screen comprises:
displaying the raw three-dimensional medical image or the three-dimensional medical image reflecting noise in a first display region of the display screen, and displaying the denoised three-dimensional medical image in a second display region of the display screen, the three-dimensional medical image in the first display region and the three-dimensional medical image in the second display region having identical display information,
wherein when the display information of the three-dimensional medical image in one of the display regions changes, the display information of the three-dimensional medical image in the other display region changes in the same manner.

8. The method according to claim 7, wherein
adding, in response to a first operation, at least a portion of the data of the raw three-dimensional medical image to the denoised three-dimensional medical image comprises:
determining, in response to the first operation, a first region in the raw three-dimensional medical image or the three-dimensional medical image reflecting noise displayed in the first display region; and
copying data from the first region, adding the copied data to a second region corresponding to the first region in the denoised three-dimensional medical image, and displaying the copied data in the second display region.

9. The method according to claim 7, wherein
when data of at least a partial region of the denoised three-dimensional medical image is cleared in response to a second operation, the at least a partial region corresponding to the cleared data is displayed in the first display region and the second display region.

10. A medical apparatus, characterized by comprising:
a data collection unit that collects data of a raw three-dimensional medical image;
a memory storing instructions; and
a processor configured to execute the instructions to:
process data of a raw three-dimensional medical image to obtain mask data of a noise-free region;
process the data of the raw three-dimensional medical image according to the mask data of the noise-free region to generate data of a denoised three-dimensional medical image; and
add, in response to a first operation, at least a portion of the data of the raw three-dimensional medical image to the data of the denoised three-dimensional medical image.

11. A non-transitory computer-readable storage medium for storing a computer program, wherein when executed by a computer, the computer program causes the computer to:
process data of a raw three-dimensional medical image to obtain mask data of a noise-free region;
process the data of the raw three-dimensional medical image according to the mask data of the noise-free region to generate data of a denoised three-dimensional medical image; and
add, in response to a first operation, at least a portion of the data of the raw three-dimensional medical image to the data of the denoised three-dimensional medical image
